(19) United States
(12) Patent Application Publication
(10) Pub. No.: US 2024/0048391 A1
(43) Pub. Date: Feb. 8, 2024

(54) INFORMATION PROVISION SYSTEM, INFORMATION PROVISION METHOD, AND NON-TRANSITORY COMPUTER-READABLE MEDIUM

(71) Applicant: NEC Corporation, Minato-ku, Tokyo (JP)

(72) Inventor: Yasuhiko TANABE, Tokyo (JP)

(73) Assignee: NEC Corporation, Minato-ku, Tokyo (JP)

(21) Appl. No.: 18/265,737

(22) PCT Filed: Dec. 17, 2020
(86) PCT No.: PCT/JP2020/047082

§ 371 Date: Jun. 7, 2023

(51) Int. Cl. H04L 9/32

(52) U.S. Cl. CPC H04L 9/3236

(57) ABSTRACT

An information provision unit searches a distributed ledger by using a retrieval key as at least a part of public information contained in an information provision request. The information provision unit acquires BC registration information associated to the retrieval key from the distributed ledger. The information provision unit searches an information DB by using the retrieval key. The information provision unit acquires operation approval information associated to the retrieval key from the information DB. The information provision unit transforms private information acquired from the information DB through searching into a hash value for verification by using a predetermined hash function. The information provision unit compares a hash value for registration with the hash value for verification.

### TECHNICAL FIELD

The present invention relates to an information provision system, an information provision method, and a non-transitory computer-readable medium.

### BACKGROUND ART

The Patent Literature 1 (PTL 1) discloses a plurality of traceability information management servers for constructing a distributed ledger system by means of a blockchain. In PTL 1, an access right is individually granted to each user client on the assumption that it is undesirable in terms of protection of personal information that a person other than the owner of a product can unlimitedly access traceability information of the product. Each traceability information management server transmits, to a user client, a portion of traceability information registered on the traceability information management server according to the access right of the user client.

### CITATION LIST

### Patent Literature

[PTL 1] Japanese Unexamined Patent Application Publication No. 2020-21134

### SUMMARY OF INVENTION

### Technical Problem

It is well known that by registering information about a life cycle of a product on a distributed ledger, authenticity of the information can be ensured.

The information about the life cycle of the product may typically include organization name information, product model number information, serial number information, process name information, workflow name information, time stamp information, approver information and operator information for a relevant workflow, and operation procedure information and operation result information for the relevant workflow.

It is safe to say that, among these types of information, the organization name information, the product model number information, the serial number information, the process name information, the workflow name information, and the time stamp information are information that may be allowed to be obtained by an unspecified person. In contrast, it is desired that the approver information and the operator information for the relevant workflow and the operation procedure information and the operation result information for the relevant workflow can be obtained only by a specified person since these types of information fall under technical information and personal information. Simply put, it can be said that the former type of information is public information to which access is not restricted while the latter type of information is private information to which access is restricted. As just described, information about a product life cycle includes two types of information, i.e., public information and private information.

Registering private information on a distributed ledger along with public information, however, carries a risk of the private information being leaked.

It is conceivable, as in PTL 1, to individually set an access right to each user client who will access the distributed ledger to limit information to be transmitted to the user client according to the access right. Even in this situation, as long as the private information is registered on the distributed ledger, the risk of the private information being leaked may not yet be eliminated.

An object of the present disclosure is, in view of the above problem, to ensure authenticity of public information and private information by means of a distributed ledger and to provide a technique to reduce a risk of the private information being leaked.

### Solution to Problem

According to a first aspect of the present disclosure, there is provided an information provision system including an information accumulation server and an information provision server,
the information accumulation server including:
   a first information acquiring means for acquiring first information containing public information and private information;
   a first information transmitting means for transmitting the first information acquired by the first information acquiring means to the information provision server; and
   a first information storing means for accumulating the first information,
the information provision server including:
   a second information acquiring means for acquiring the first information from the information accumulation server;
   a transformation means for transforming the private information of the first information into a first hash value by using a predetermined hash function;
   an information generating means for generating second information containing the public information of the first information and the first hash value;
   a registration means for registering the second information on a distributed ledger by means of a blockchain;
   a request receiving means for receiving an information provision request containing at least a part of the public information; and
   a second information transmitting means for transmitting, when a sender of the information provision request has an access right to the private information, the public information and the private information to the sender in response to the information provision request, wherein the second information transmitting means is configured to:
   search the distributed ledger by using a retrieval key being at least a part of the public information contained in the information provision request;
   acquire the second information associated to the retrieval key from the distributed ledger;
   search the first information storing means by using the retrieval key;
   acquire the first information associated to the retrieval key from the first information storing means;
   transform the private information acquired from the first information storing means through searching by using the predetermined hash function into a second hash value;
   compare the first hash value with the second hash value; and
   transmit, when the first hash value and the second hash value match, the public information associated to the retrieval key and the private information acquired from the first information storing means through searching, to the sender.

According to a second aspect of the present disclosure, there is provided an information provision system including an information accumulation server and an information provision server,
the information accumulation server including:
   a first information acquiring means for acquiring first information containing public information and private information;
   a first information transmitting means for transmitting the first information acquired by the first information acquiring means to the information provision server; and
      a first information storing means for accumulating the private information of the first information,
the information provision server including:
   a second information acquiring means for acquiring the first information from the information accumulation server;
   a transformation means for transforming the private information of the first information into a first hash value by using a predetermined hash function;
   an information generating means for generating second information containing the public information of the first information and the first hash value;
   a registration means for registering the second information on a distributed ledger by means of a blockchain;
   a request receiving means for receiving an information provision request containing at least a part of the public information; and
   a second information transmitting means for transmitting, when a sender of the information provision request has an access right to the private information, the public information and the private information to the sender in response to the information provision request, wherein the second information transmitting means is configured to:
   search the distributed ledger by using a retrieval key as at least a part of the public information contained in the information provision request;
   acquire the second information associated to the retrieval key from the distributed ledger;
   acquire a plurality of pieces of the private information accumulated in the first information acquiring means from the first information storing means;
   transform a plurality of pieces of the private information acquired from the first information storing means by using the predetermined hash function into second hash values, compare the first hash value with a plurality of the second hash values; and
   transmit the public information associated to the retrieval key and the private information associated to one of the second hash values that matches the first hash value to the sender.

According to a third aspect of the present disclosure, there is provided an information provision method using an information provision system including an information accumulation server and an information provision server, the method including:
a first information acquisition stage of, by the information accumulation server, acquiring first information containing public information and private information;
a first information transmission stage of, by the information accumulation server, transmitting the first information acquired in the first information acquisition stage, to the information provision server;
a first information storage stage of, by the information accumulation server, accumulating the first information;
a second information acquisition stage of, by the information provision server, acquiring the first information from the information accumulation server;
a transformation stage of, by the information provision server, transforming the private information of the first information into a first hash value by using a predetermined hash function;
an information generation stage of, by the information provision server, generating second information containing the public information of the first information and the first hash value;
a registration stage of, by the information provision server, registering the second information on a distributed ledger by means of a blockchain;
a request reception stage of, by the information provision server, receiving an information provision request containing at least a part of the public information; and
a second information transmission stage of, by the information provision server, transmitting, when a sender of the information provision request has an access right to the private information, the public information and the private information to the sender in response to the information provision request, wherein the second information transmission stage includes:
   searching the distributed ledger by using a retrieval key as at least a part of the public information contained in the information provision request;
   acquiring the second information associated to the retrieval key from the distributed ledger;
   searching the information accumulation server by using the retrieval key;
   acquiring the first information associated to the retrieval key from the information accumulation server;
   transforming the private information acquired from the information accumulation server through searching by using the predetermined hash function into a second hash value;
   comparing the first hash value with the second hash value; and
   transmitting, when the first hash value and the second hash value match, the public information associated to the retrieval key and the private information acquired from the information accumulation server through searching, to the sender.

According to a fourth aspect of the present disclosure, there is provided an information provision method using an information provision system including an information accumulation server and an information provision server, the method including:
a first information acquisition stage of, by the information accumulation server, acquiring first information containing public information and private information;
a first information transmission stage of, by the information accumulation server, transmitting the first information acquired in the first information acquisition stage to the information provision server;
a first information storage stage of, by the information accumulation server, accumulating the private information of the first information;
a second information acquisition stage of, by the information provision server, acquiring the first information from the information accumulation server;
a transformation stage of, by the information provision server, transforming the private information of the first information into a first hash value by using a predetermined hash function;
an information generation stage of, by the information provision server, generating second information containing the public information of the first information and the first hash value;
a registration stage of, by the information provision server, registering the second information on a distributed ledger by means of a blockchain;
a request reception stage of, by the information provision server, receiving an information provision request containing at least a part of the public information; and
a second information transmission stage of, by the information provision server, transmitting, when a sender of the information provision request has an access right to the private information, the public information and the private information to the sender in response to the information provision request, wherein the second information transmission stage includes:
   searching the distributed ledger by using a retrieval key as at least a part of the public information contained in the information provision request;
   acquiring the second information associated to the retrieval key from the distributed ledger;
   acquiring a plurality of pieces of the private information accumulated in the information accumulation server from the information accumulation server;
   transforming a plurality of pieces of the private information acquired from the information accumulation server by using the predetermined hash function into second hash values;
   comparing the first hash value with the second hash values; and
   transmitting the public information associated to the retrieval key and the private information associated to one of the second hash values that matches the first hash value, to the sender.

### Advantageous Effects of Invention

According to the present disclosure, authenticity of public information and private information is ensured by means of a distributed ledger and a risk of the private information being leaked is reduced.

### BRIEF DESCRIPTION OF DRAWINGS

FIG. 1 is a functional block diagram of an information provision system (a first example embodiment);

FIG. 2 is a schematic diagram of the information provision system (a second example embodiment);

FIG. 3 is a functional block diagram of an information accumulation server (the second example embodiment);

FIG. 4 illustrates one specific example of operation approval information (the second example embodiment);

FIG. 5 illustrates one specific example of plural pieces of the operation approval information accumulated in an information DB (the second example embodiment);

FIG. 6 is a functional block diagram of an information provision server (the second example embodiment);

FIG. 7 illustrates one specific example of plural pieces of BC registration information registered on a distributed ledger (the second example embodiment);

FIG. 8 is a sequence diagram of the information provision system (the second example embodiment);

FIG. 9 is a sequence diagram of the information provision system (the second example embodiment);

FIG. 10 illustrates one specific example of the BC registration information retrieved by the information provision unit from the distributed ledger (the second example embodiment);

FIG. 11 illustrates one specific example of the operation approval information retrieved by the information provision unit from the information accumulation server (the second example embodiment);

FIG. 12 illustrates one specific example of information provided by the information provision unit to a retrieval terminal (the second example embodiment);

FIG. 13 illustrates one specific example of plural pieces of private information accumulated in the information DB (a third example embodiment);

FIG. 14 is a sequence diagram of the information provision system (the third example embodiment);

FIG. 15 is a diagram illustrating a correspondence relationship between the plural pieces of private information and hash values of the plural pieces of private information (the third example embodiment); and

FIG. 16 is a diagram illustrating a process of replacing a hash value for registration with the private information (the third example embodiment).

### EXAMPLE EMBODIMENT

### First Example Embodiment

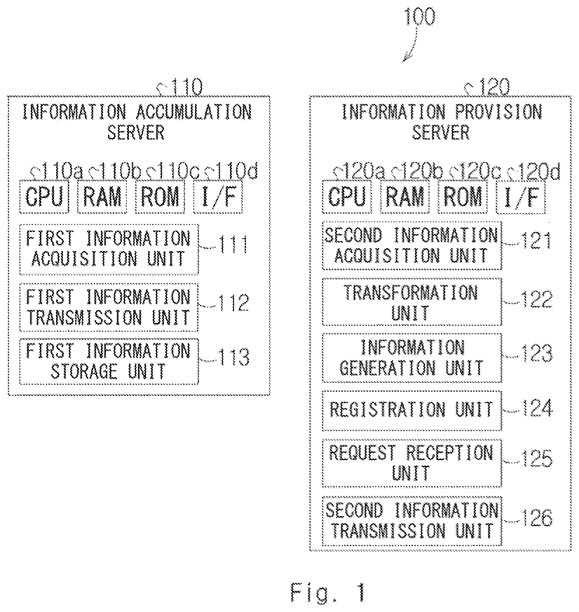

Referring to FIG. 1, an information provision system 100 will be described below.

An Information provision system 100 includes an information accumulation server 110 and an information provision server 120.

The information accumulation server 110 includes a CPU (Central Processing Unit) 110a as a central arithmetic operation processor, a RAM (Random Access Memory) 110b that is freely readable/writable, a read-only ROM (Read Only Memory) 110c, and a communication interface 110d. With the CPU 110a reading and executing a control program stored in the ROM 110c, the control program causes hardware such as the CPU 110a to function as various types of functional units.

The various types of functional units include a first information acquisition unit 111, a first information transmission unit 112, and a first information storage unit 113.

The first information acquisition unit 111 obtains first information containing public information and private information. The first information acquisition unit 111 is one specific example of a first information acquiring means.

The first information transmission unit 112 transmits the first information obtained by the first information acquisition unit 111 to the information provision server 120. The first information transmission unit 112 is one specific example of a first information transmitting means.

The first information storage unit 113 accumulates the first information. The first information storage unit 113 is one specific example of a first information storing means.

The information provision server 120 includes a CPU (Central Processing Unit) 120a as a central arithmetic operation processor, a RAM (Random Access Memory) 120b that is freely readable/writable, a read-only ROM (Read Only Memory) 120c, and a communication interface 120d. With the CPU 120a reading and executing a control program stored in the ROM 120c, the control program causes hardware such as the CPU 120a to function as various types of functional units.

The various types of functional units include a second information acquisition unit 121, a transformation unit 122, an information generation unit 123, a registration unit 124, a request reception unit 125, and a second information transmission unit 126.

The second information acquisition unit 121 retrieves the first information from the information accumulation server 110. The second information acquisition unit 121 is one specific example of a second information acquiring means.

The transformation unit 122 transforms the private information of the first information into a first hash value using a predetermined hash function. The transformation unit 122 is one specific example of a transformation means.

The information generation unit 123 generates second information containing the public information of the first information and the first hash value. The information generation unit 123 is one specific example of an information generating means.

The registration unit 124 registers the second information on a distributed ledger by means of a blockchain. The registration unit 124 is one specific example of a registration means.

The request reception unit 125 receives an information provision request containing at least a portion of the public information. The request reception unit 125 is one specific example of a request receiving means.

The second information transmission unit 126 transmits, when a sender of the information provision request has an access right to the private information, the public information and the private information to the sender in response to the information provision request. The second information transmission unit 126 is one specific example of a second information transmitting means.

The second information transmission unit 126 searches the distributed ledger using a retrieval key that is at least a portion of the public information contained in the information provision request.

The second information transmission unit 126 retrieves the second information that corresponds to the retrieval key from the distributed ledger.

The second information transmission unit 126 searches the first information storage unit 113 using the retrieval key.

The second information transmission unit 126 retrieves the first information that corresponds to the retrieval key from the first information storage unit 113.

The second information transmission unit 126 transforms the private information retrieved from the first information storage unit 113 through the search into a second hash value using a predetermined hash function.

The second information transmission unit 126 compares the first hash value with the second hash value.

The second information transmission unit 126 transmits, when the first hash value and the second hash value match, the public information corresponding to the retrieval key and the private information retrieved from the first information storage unit 113 through the search to the sender.

According to the configuration described above, authenticity of the public information and the private information can be ensured by means of the distributed ledger and a risk of the private information being leaked can be reduced.

### Second Example Embodiment

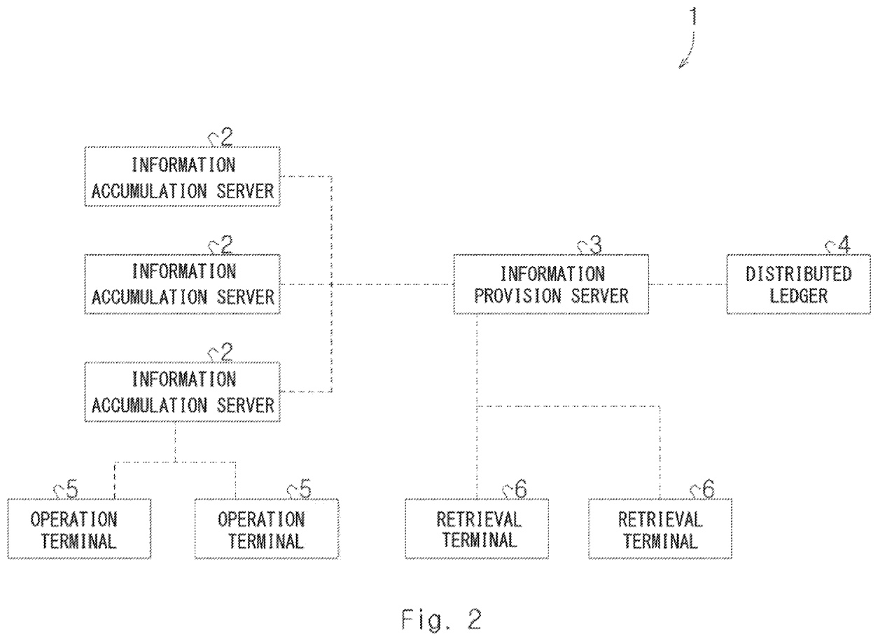

Next, with reference to FIG. 2 to FIG. 12, a second example embodiment will be described. First, a problem for the second example embodiment will be described.

It is well known that by registering information about a life cycle of a product on a distributed ledger, authenticity of the information can be ensured.

The information about the life cycle of the product may typically include organization name information, product model number information, serial number information, process name information, workflow name information, time stamp information, approver information and operator information for a relevant workflow, and operation procedure information and operation result information for the relevant workflow.

It is safe to say that, among these types of information, the organization name information, the product model number information, the serial number information, the process name information, the workflow name information, and the time stamp information are information that may be allowed to be obtained by an unspecified person. In contrast, it is desired that the approver information and the operator information for the relevant workflow and the operation procedure information and the operation result information for the relevant workflow can be obtained only by a specified person since these types of information fall under technical information and personal information. Simply put, it can be said that the former type of information is public information to which access is not restricted while the latter type of information is private information to which access is restricted. As just described, information about a product life cycle includes two types of information, i.e., public information and private information.

Registering the private information on a distributed ledger along with the public information, however, carries a risk of the private information being leaked.

It is conceivable, as in PTL 1, to individually set an access right to each user client who will access the distributed ledger to limit information to be transmitted to the user client according to the access right. Even in this situation, as long as the private information is registered on the distributed ledger, the risk of the private information being leaked may not yet be eliminated.

The problem for the present example embodiment is as described above, and an information provision system 1 for solving the above problem is illustrated in FIG. 2. The information provision system 1 is characterized in that it ensures authenticity of the public information and the private information by means of the distributed ledger and reduces a risk of the private information being leaked. The information provision system 1 illustrated in FIG. 2 will be described in detail below.

The Information provision system 1 includes at least one information accumulation server 2 and an information provision server 3. As illustrated in FIG. 2, the information provision system 1 according to the present example embodiment includes a plurality of information accumulation servers 2. The information provision system 1 may further include a distributed ledger 4.

The information provision system 1 may further include at least one operation terminal 5 and at least one retrieval terminal 6. The information provision system 1 according to the present example embodiment includes a plurality of operation terminals 5 and a plurality of retrieval terminals 6.

The plurality of information accumulation servers 2 are servers managed by a business owner who engages in various types of processes that compose a product life cycle. The plurality of information accumulation servers 2 typically include servers managed by a business owner who engages in inspection operations for products, servers managed by a business owner who engages in shipment operations for products, and servers managed by a business owner who engages in logistics operations for products.

Each operation terminal 5 is a terminal capable of communicating with one of the plurality of information accumulation servers 2. An operator who engages in the product life cycle executes a workflow according to a predetermined operation procedure and achieves an operation result as the result of execution. The operator registers organization name information, product model number information, serial number information, process name information, workflow name information, operation procedure information, operation result information, and operator information on the information accumulation server 2 using the operation terminal 5. The operator requests an approver to approve the operation procedure and the operation result. In response to this request, the approver approves the operation procedure and the operation result, and registers approver information on the information accumulation server 2 using the operation terminal 5. Information including the information the operator registers on the information accumulation server 2 and the information the approver registers on the information accumulation server 2 will be referred to as operation approval information below. The operation approval information is one specific example of the first information.

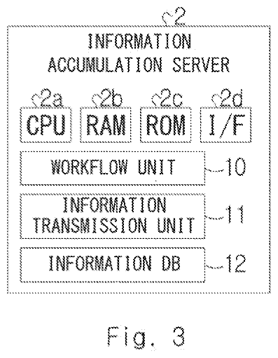

FIG. 3 illustrates a functional block diagram of the information accumulation server 2. As illustrated in FIG. 3, the information accumulation server 2 includes a CPU (Central Processing Unit) 2a as a central arithmetic operation processor, a RAM (Random Access Memory) 2b that is freely readable/writable, a read-only ROM (Read Only Memory) 2c, and a communication interface 2d. With the CPU 2a reading and executing a control program stored in the ROM 2c, the control program causes hardware such as the CPU 2a to function as various types of functional units.

The various types of functional units include a workflow unit 10, an information transmission unit 11, and an information DB 12.

The workflow unit 10 obtains the operation approval information containing the public information and the private information from each operation terminal 5 and registers the obtained operation approval information on the information DB 12. Specifically, the workflow unit 10 adds time stamp information to the obtained operation approval information and registers the operation approval information on the information DB12. The workflow unit 10 is one specific example of the first information acquiring means.

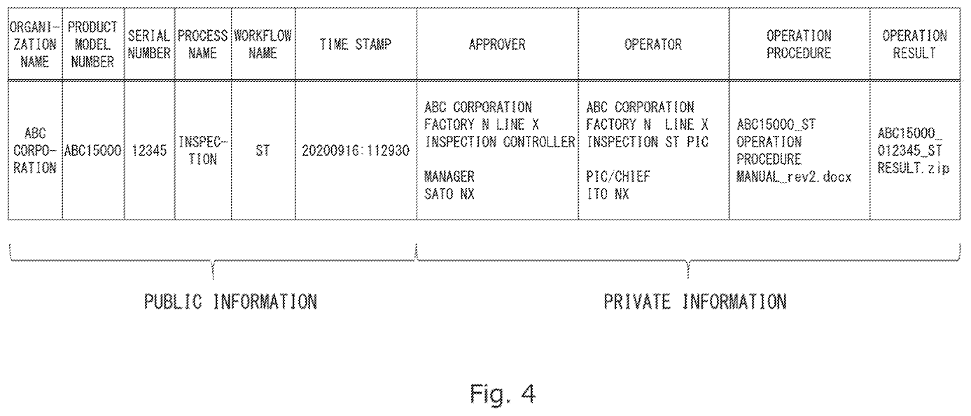

FIG. 4 illustrates the operation approval information obtained by the workflow unit 10. As illustrated in FIG. 4, the operation approval information contains public information and private information (information required to be concealed). The public information includes the organization name information, the product model number information, the serial number information, the process name information, the workflow name information, and the time stamp information. The private information includes the approver information, the operator information, the operation procedure information, and the operation result information. In the present example embodiment, the public information contains plural pieces of information; however, the public information may be alternatively composed of only a single piece of information. Similarly, in the present example embodiment, the private information contains plural pieces of information; however, the private information may be alternatively composed of only a single piece of information.

The information transmission unit 11 transmits the operation approval information that the workflow unit 10 had obtained and to which the time stamp information was added to the information provision server 3. The information transmission unit 11 is one specific example of the first information transmitting means.

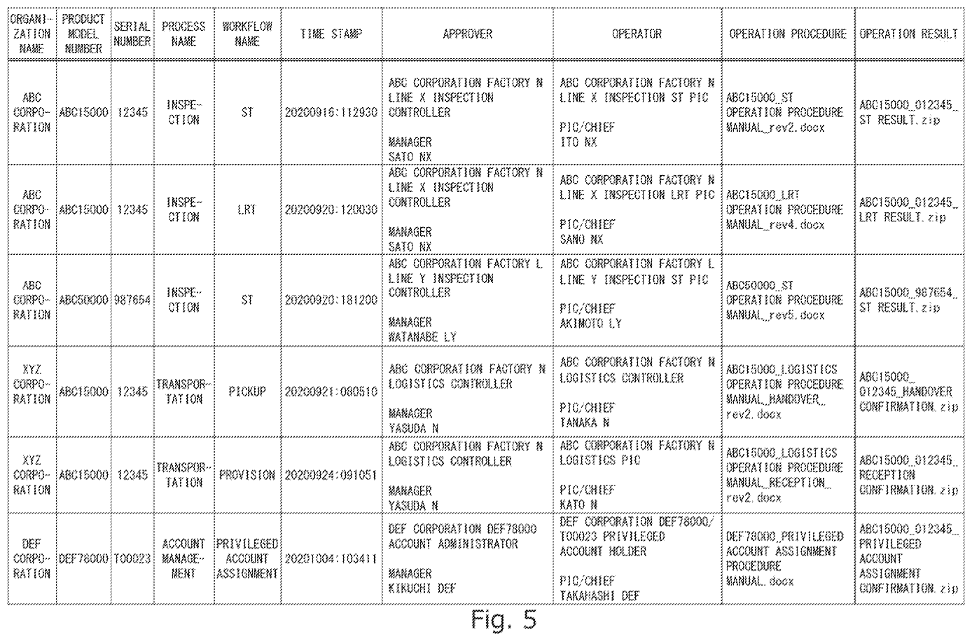

The information DB 12 accumulates the operation approval information. The information DB 12 is one specific example of the first information storing means. FIG. 5 illustrates plural pieces of the operation approval information accumulated in the information DB 12.

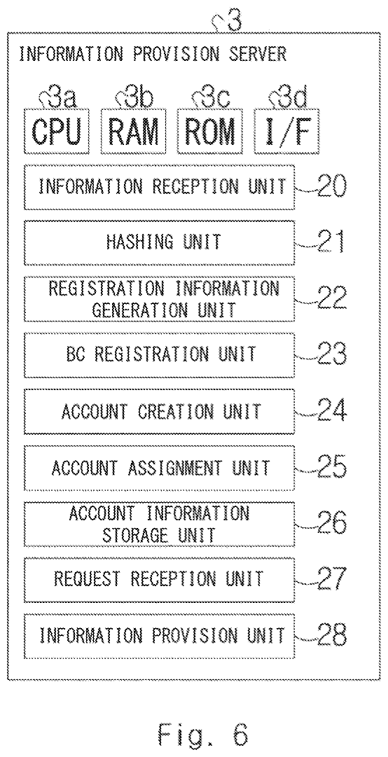

FIG. 6 illustrates a functional block diagram of the information provision server 3. As illustrated in FIG. 6, the information provision server 3 includes a CPU (Central Processing Unit) 3a as a central arithmetic operation processor, a RAM (Random Access Memory) 3b that is freely readable/writable, a read-only ROM (Read Only Memory) 3c, and a communication interface 3d. With the CPU 3a reading and executing a control program stored in the ROM 3c, the control program causes hardware such as the CPU 3a to function as various types of functional units.

The various types of functional units include an information reception unit a hashing unit 21, a registration information generation unit 22, a BC registration unit 23, an account creation unit 24, an account assignment unit 25, an account information storage unit 26, a request reception unit 27, an information provision unit 28.

The information reception unit 20 receives and obtains the operation approval information from the information accumulation server 2. The information reception unit 20 is one specific example of the second information acquiring means.

The hashing unit 21 transforms the private information of the operation approval information obtained by the information reception unit 20 by means of a predetermined hash function into a hash value for registration. The hash value for registration is one specific example of the first hash value.

The registration information generation unit 22 generates BC registration information containing the public information of the operation approval information and the hash value for registration. The BC registration information is one specific example of the second information.

The BC registration unit 23 registers the BC registration information on the distributed ledger 4.

With reference to FIG. 2, the distributed ledger 4 will be described here. The distributed ledge 4 is typically a distributed ledger utilizing a consortium blockchain technology and composed of a plurality of nodes. The plurality of information provision servers 3 illustrated in FIG. 2 may function as the plurality of nodes that compose the distributed ledger 4, or a plurality of servers other than the plurality of information provision servers 3 may function as the plurality of nodes that compose the distributed ledger 4.

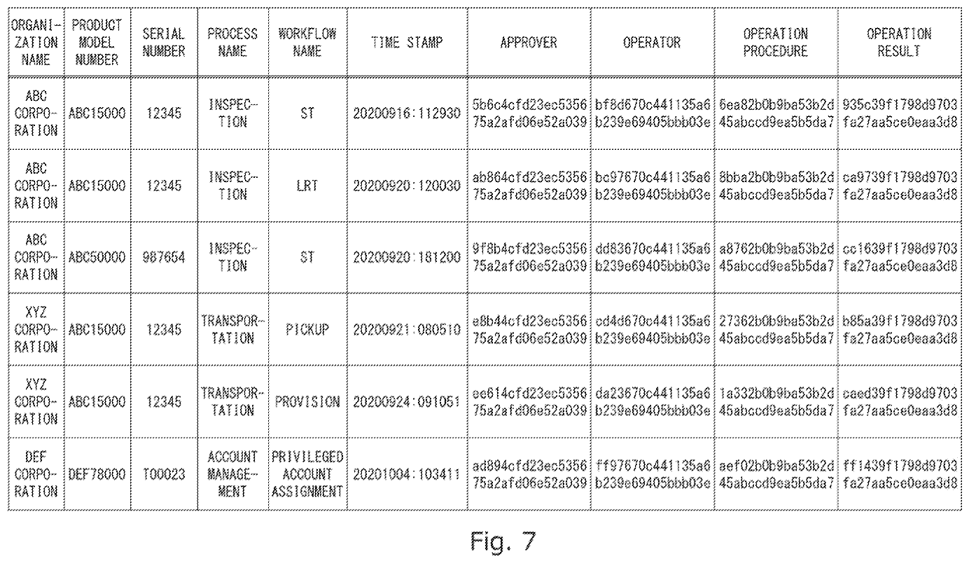

FIG. 7 illustrates plural pieces of the BC registration information registered on the distributed ledger 4. As illustrated in FIG. 7, the BC registration information registered on the distributed ledger 4 does not contain private information; instead, the BC registration information contains a hash value for registration obtained by hashing the private information. Therefore, the private information will not be leaked directly from the distributed ledger 4. Because hashing is an irreversible transformation.

Referring back to FIG. 6, when a user who wishes to refer to the operation approval information requests for an account via the retrieval terminal 6, the account creation unit 24 generates account information for the user. The account information typically contains account name information and access right information relating to whether an access right to private information is granted or not. The account creation unit 24 stores the generated account information in the account information storage unit 26.

The account information storage unit 26 stores plural pieces of account information.

The account assignment unit 25 assigns the account information to the user.

For example, when an auditor requests for an account, the account creation unit 24 generates account information in which an access right to private information is granted, and the account creation unit 24 assigns the account information to the auditor. In contrast, when a person other than an auditor requests for an account, the account creation unit 24 generates account information in which an access right to private information is not granted, and the account creation unit 24 assigns the account information to the person.

The request reception unit 27 receives an information provision request. The information provision request typically contains at least a portion of the public information. The information provision request may contain all of the public information. When the auditor or other person operates the retrieval terminal 6, the retrieval terminal 6 transmits the information provision request to the information provision server 3. The request reception unit 27 receives the information provision request from the retrieval terminal 6. The request reception unit 27 is one specific example of the request receiving means.

The information provision unit 28 transmits, when a sender of the information provision request has an access right to the private information, the public information and the private information to the sender in response to the information provision request. The information provision unit 28 is one specific example of the second information transmitting means.

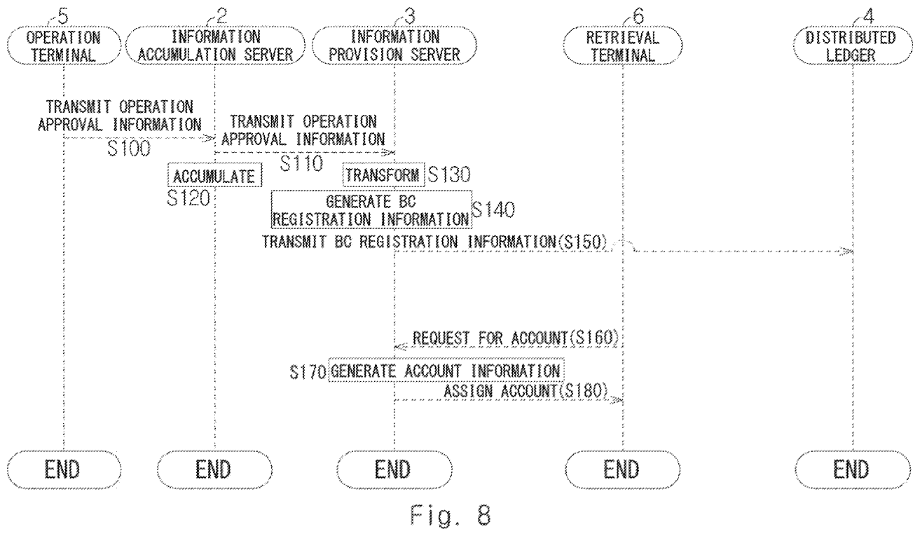

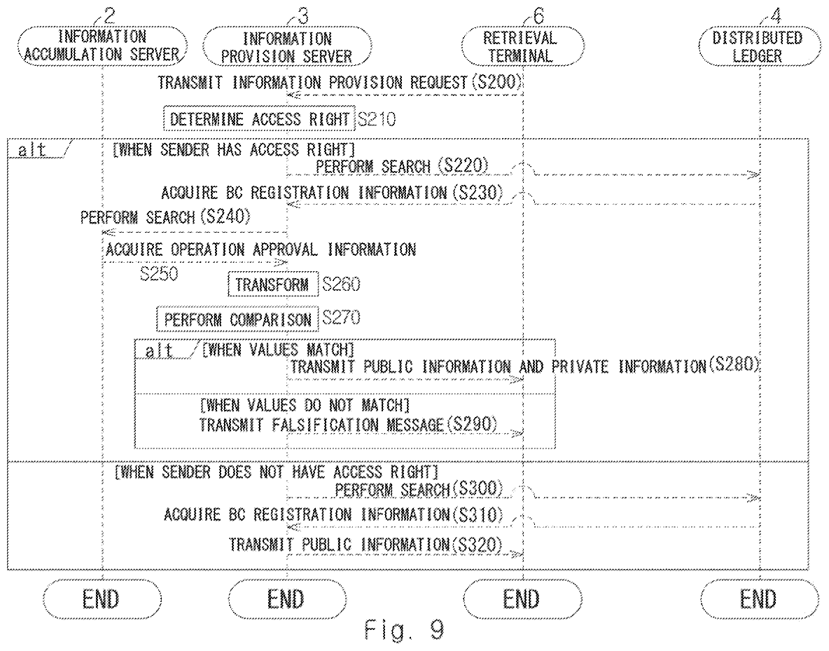

Next, with reference to FIG. 8 to FIG. 12, operations of the information provision system 1 will be described. FIG. 8 and FIG. 9 illustrate sequence diagrams of the information provision system 1.

Referring to FIG. 8, first, the operator and the approver input the operation approval information into the operation terminal 5. The operation terminal 5 transmits the input operation approval information to the information accumulation server 2 (S100).

The workflow unit 10 of the information accumulation server 2 obtains the operation approval information from the operation terminal 5 (S100) and adds time stamp information to the operation approval information. The information transmission unit 11 transmits the operation approval information illustrated in FIG. 4 to the information provision server 3 with the operation approval information being obtained by the workflow unit 10 from the operation terminal 5 as a trigger (S110). The workflow unit 10 also accumulates, as illustrated in FIG. 5, the obtained operation approval information in the information DB 12 (S120).

The information reception unit 20 of the information provision server 3 receives and obtains the operation approval information from the information accumulation server 2 (S110). The hashing unit 21 transforms the private information of the operation approval information obtained by the information reception unit 20 by means of the predetermined hash function into a hash value for registration (S130).

The registration information generation unit 22 generates BC registration information containing the public information of the operation approval information and the hash value for registration (S140). The BC registration unit 23 registers the BC registration information generated by the registration information generation unit 22 on the distributed ledger 4 (S150). FIG. 7 illustrates plural pieces of the BC registration information stored in the distributed ledger 4.

The processes from step S100 to step S150 are repeated every time the operation approval information is input into the operation terminal 5.

Next, when a user who wishes to refer to the operation approval information requests for an account via the retrieval terminal 6 (S160), the account creation unit 24 generates account information for the user (S170). The account creation unit 24, in addition to storing the generated account information in the account information storage unit 26, assigns the account information to the user (S180).

Next, refer to FIG. 9. When the user who wishes to refer to the operation approval information logs in to the retrieval terminal 6 using the account information provided by the information provision server 3 and operates the retrieval terminal 6, the retrieval terminal 6 transmits an information provision request to the information provision server 3 (S200). Specifically, the user who wishes to refer to the operation approval information inputs the public information of the operation approval information into the retrieval terminal 6. Typically, the user who wishes to refer to the operation approval information inputs at least a portion of the public information of the operation approval information into the retrieval terminal 6. The retrieval terminal 6 generates an information provision request containing at least a portion of the public information input by the user, and transmits the generated information provision request to the information provision server 3 (S200). In the present example embodiment, the information provision request may contain at least a portion of the public information and the account information owned by the user who is the sender.

The information provision unit 28 of the information provision server 3 refers to the account information storage unit 26 to determine whether the account for the sender of the information provision request has an access right to the private information (S210).

### [In Case the Account has an Access Right to the Private Information]

When it is determined in step S210 that the account for the sender of the information provision request has an access right to the private information, the information provision unit 28 searches the distributed ledger 4 using a retrieval key that is at least a portion of the public information contained in the information provision request (S220). For the sake of convenience, it is assumed here that the retrieval key above contains “product number information”, “serial number information”, and “process name information”, and the “product number information” is “ABC15000” and the “serial number information” is “12345” and the “process name information” is “inspection”.

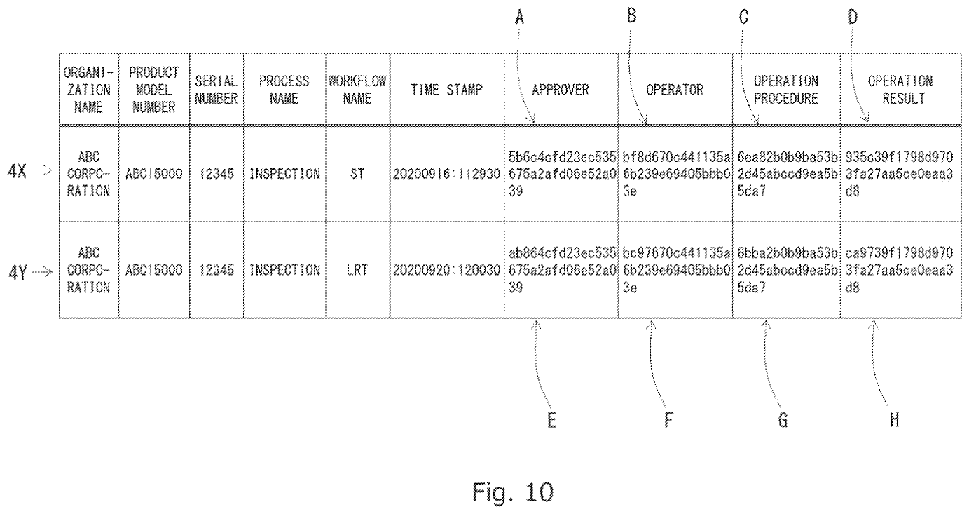

The information provision unit 28 retrieves the BC registration information that corresponds to the retrieval key above from the distributed ledger 4 (S230). FIG. 10 illustrates the BC registration information retrieved by the information provision unit 28 from the distributed ledger 4. As illustrated in FIG. 10, two pieces of the BC registration information corresponded to the retrieval key above. Therefore, the information provision unit 28 retrieves the two pieces of the BC registration information illustrated in FIG. 10 (i.e., BC registration information 4X and BC registration information 4Y) from the distributed ledger 4.

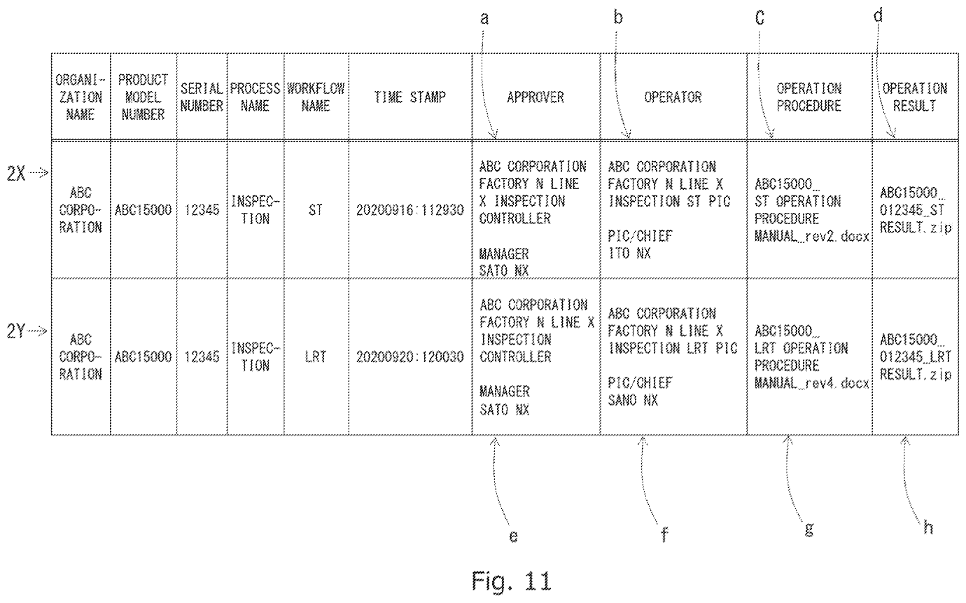

Referring back to FIG. 9, the information provision unit 28 searches the information DB 12 of the information accumulation server 2 using the retrieval key above (S240). The information provision unit 28 then retrieves the operation approval information that corresponds to the retrieval key above from the information DB 12 (S250). FIG. 11 illustrates the operation approval information retrieved by the information provision unit 28 from the information DB 12. As illustrated in FIG. 11, two pieces of the operation approval information corresponded to the retrieval key above. Therefore, the information provision unit 28 retrieves the two pieces of the operation approval information illustrated in FIG. 11 (i.e., operation approval information 2X and operation approval information 2Y) from the information DB 12.

Subsequently, the information provision unit 28 transforms the private information retrieved from the information DB 12 through the search using a predetermined hash function into a hash value for verification (S260). The hash value for verification is one specific example of the second hash value.

The information provision unit 28 then compares the hash value for registration of the BC registration information retrieved in step S230 with the hash value for verification obtained by hashing in step S260 (S270). Referring to FIG. 10 and FIG. 11, the comparison above will be specifically described below.

FIG. 10 illustrates the two pieces of the BC registration information in (i.e., the BC registration information 4X and the BC registration information 4Y). FIG. 11 illustrates the operation approval information 2X and the operation approval information 2Y as the two pieces of the operation approval information.

As illustrated in FIG. 10, the BC registration information 4X contains a hash value for registration A obtained by hashing the approver information, a hash value for registration B obtained by hashing the operator information, a hash value for registration C obtained by hashing the operation procedure information, and a hash value for registration D obtained by hashing the operation result information. Similarly, the BC registration information 4Y contains a hash value for registration E obtained by hashing the approver information, a hash value for registration F obtained by hashing the operator information, a hash value for registration G obtained by hashing the operation procedure information, and a hash value for registration H obtained by hashing the operation result information.

As illustrated in FIG. 11, the operation approval information 2X contains the approver information a, the operator information b, the operation procedure information c, and the operation result information d. Similarly, the operation approval information 2Y contains the approver information e, the operator information f, the operation procedure information g, and the operation result information h.

The information provision unit 28 compares the hash value for registration A of the BC registration information 4X with a hash value for verification obtained by hashing the approver information a of the operation approval information 2X (S270). When these hash values match as the result of comparison, the information provision unit 28 determines that the approver information a of the operation approval information 2X is not falsified.

The information provision unit 28 compares the hash value for registration B of the BC registration information 4X with a hash value for verification obtained by hashing the operator information b of the operation approval information 2X in the same manner. When these hash values match as the result of comparison, the information provision unit 28 determines that the operator information b of the operation approval information 2X is not falsified.

The information provision unit 28 also performs comparison in the same manner with regard to the hash value for registration C and the operation procedure information c and the hash value for registration D and the operation result information d to determine whether falsification has been made or not.

The information provision unit 28 compares the hash value for registration E of the BC registration information 4Y with a hash value for verification obtained by hashing the approver information e of the operation approval information 2Y. When these hash values match as the result of comparison, the information provision unit 28 determines that the approver information e of the operation approval information 2Y is not falsified.

The information provision unit 28 compares the hash value for registration F of the BC registration information 4Y with a hash value for verification obtained by hashing the operator information f of the operation approval information 2Y in the same manner. When these hash values match as the result of comparison, the information provision unit 28 determines that the operator information f of the operation approval information 2Y is not falsified.

The information provision unit 28 also performs comparison in the same manner with regard to the hash value for registration G and the operation procedure information g and the hash value for registration H and the operation result information h to determine whether falsification has been made or not

It should be noted that, as illustrated in FIG. 10, pieces of public information in plural pieces of the BC registration information do not completely match with each other. Similarly, as illustrated in FIG. 11, pieces of public information in plural pieces of the operation approval information do not match with each other. In the example illustrated in FIG. 10, the workflow name information and the time stamp information of the public information of the BC registration information, both of which are information not contained in the retrieval key, are different in the plural pieces of the BC registration information. The same applies to FIG. 11. Therefore, the information provision unit 28 can easily recognize which BC registration information corresponds to which operation approval information by referring to the workflow name information or the time stamp information every time a hash value for registration and a hash value for verification are compared.

When it is determined as the result of comparison described above that none of the approver information, the operator information, the operation procedure information, and the operation result information contained in the private information of the operation approval information is falsified, the information provision unit 28 determines that the entire private information of the operation approval information is not falsified. After this determination, the information provision unit 28 transmits the public information corresponding to the retrieval key and the private information retrieved from the information DB 12 through the search to the sender (S280). Note that “the public information corresponding to the retrieval key” may be the public information retrieved from the distributed ledger 4 through the search, or may be the public information retrieved from the information DB 12 through the search. Because these pieces of public information are identical. In other words, after this determination, the information provision unit 28 may transmit the operation approval information retrieved from the information DB 12 through the search to the sender.

When it is determined as the result of comparison described above that one of the approver information, the operator information, the operation procedure information, and the operation result information contained in the private information of the operation approval information is falsified, the information provision unit 28 determines that the private information of the operation approval information stored in the information DB 12 is falsified. After this determination, the information provision unit 28 transmits a falsification message indicating that the private information of the operation approval information stored in the information DB 12 is falsified to the retrieval terminal 6 (S290).

[in Case the Account does not have an Access Right to the Private Information]

When it is determined in step S210 that the account for the sender of the information provision request does not have an access right to the private information, the information provision unit 28 searches the distributed ledger 4 using a retrieval key that is at least a portion of the public information contained in the information provision request (S300).

The information provision unit 28 then retrieves the BC registration information that corresponds to the retrieval key from the distributed ledger 4 (S310). FIG. 10 illustrates the BC registration information retrieved by the information provision unit 28 from the distributed ledger 4. As illustrated in FIG. two pieces of the BC registration information corresponded to the retrieval key above. Therefore, the information provision unit 28 retrieves the two pieces of the BC registration information illustrated in FIG. 10 (i.e., the BC registration information 4X and the BC registration information 4Y) from the distributed ledger 4.

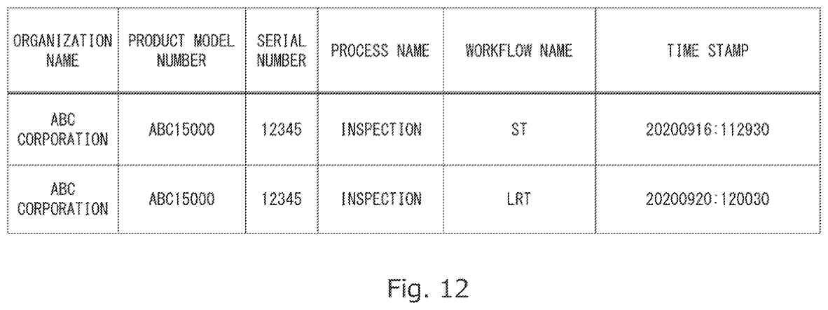

Subsequently, the information provision unit 28 transmits the public information of the BC registration information retrieved from the distributed ledger 4 to the retrieval terminal 6 (S320). At this time, as illustrated in FIG. 10, the information provision unit 28 may transmit, without deleting the hash values for registration of the BC registration information retrieved from the distributed ledger 4, the BC registration information to the retrieval terminal 6. Alternatively, the information provision unit 28 may transmit, as illustrated in FIG. 12, after deleting the hash values for registration of the BC registration information retrieved from the distributed ledger 4, only the public information of the BC registration information to the retrieval terminal 6.

The second example embodiment of the present disclosure has been described above. The second example embodiment has the following features.

The Information provision system 1 includes the information accumulation server 2 and the information provision server 3.

The information accumulation server includes the workflow unit 10, the information transmission unit 11, and the information DB 12. The workflow unit (the first information acquiring means) obtains operation approval information (the first information) containing public information and private information. The information transmission unit 11 (the first information transmitting means) transmits the operation approval information that the workflow unit 10 had obtained to the information provision server 3. The information DB 12 (the first information storing means) accumulates the operation approval information.

The information provision server 3 includes the information reception unit the hashing unit 21, the registration information generation unit 22, the BC registration unit 23, the request reception unit 27, and the information provision unit 28. The information reception unit 20 (the second information acquiring means) obtains the operation approval information from the information accumulation server 2. The hashing unit 21 (the transformation means) transforms the private information of the operation approval information by means of the predetermined hash function into a hash value for registration (the first hash value). The registration information generation unit 22 (the information generating means) generates BC registration information (the second information) containing the public information of the operation approval information and the hash value for registration. The BC registration unit 23 (the registration means) registers the BC registration information on the distributed ledger 4 by means of a blockchain. The request reception unit 27 (the request receiving means) receives an information provision request containing at least a portion of the public information. The information provision unit 28 (the second information transmitting means) transmits, when a sender of the information provision request has an access right to the private information, the public information and the private information to the sender in response to the information provision request.

The information provision unit 28 searches the distributed ledger 4 using a retrieval key that is at least a portion of the public information contained in the information provision request (S220). The information provision unit 28 retrieves the BC registration unit 23 that corresponds to the retrieval key from the distributed ledger 4 (S230). The information provision unit 28 searches the information DB 12 using the retrieval key (S240). The information provision unit 28 retrieves the operation approval information that corresponds to the retrieval key from the information DB 12 (S250). The information provision unit 28 transforms the private information retrieved from the information DB 12 through the search using the predetermined hash function into a hash value for verification (the second hash value) (S260). The information provision unit 28 compares the hash value for registration with the hash value for verification (S270). The information provision unit 28 transmits, when the hash value for registration and the hash value for verification match, the public information corresponding to the retrieval key and the private information retrieved from the information DB 12 through the search to the sender (S280).

The information provision system 1 described above can ensure authenticity of the public information and the private information by means of the distributed ledger and reduce a risk of the private information being leaked.

The information provision unit 28 determines, when the hash value for registration and the hash value for verification do not match, that the private information accumulated in the information DB 12 is falsified (S270, S290).

The information provision unit 28 also searches, when a sender of the information provision request does not have an access right to the private information, the distributed ledger using the retrieval key (S300). The information provision unit 28 retrieves the public information of the BC registration information that corresponds to the retrieval key from the distributed ledger 4 (S310). The information provision unit 28 transmits the public information retrieved from the distributed ledger 4 to the sender (S320). According to what has been described above, a configuration that does not transmit private information to a sender who does not have an access right to the private information is achieved.

### A Variation Example

The second example embodiment described above may be changed, for example, as follows.

In step S270 in FIG. 9, the information provision unit 28 may compare the public information of the operation approval information retrieved from the information DB 12 through the search with the public information of the BC registration information retrieved from the distributed ledger 4. The information provision unit 28 may determine, when these pieces of information do not match, that the public information accumulated in the information DB 12 is falsified. In this case, in step S290, the information provision unit 28 may transmit a falsification message indicating that the public information accumulated in the information DB 12 is falsified to the retrieval terminal 6.

### Third Example Embodiment

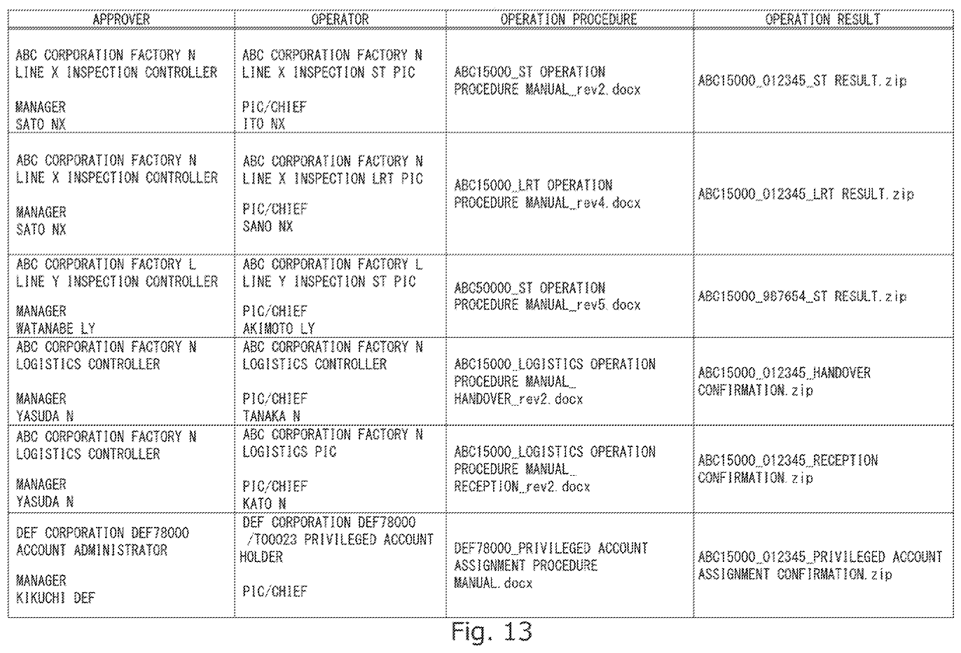

Next, with reference to FIG. 13 to FIG. 16, a third example embodiment will be described. The present example embodiment will be described below focusing on differences from the second example embodiment described above, and redundant description thereof is omitted.

In the second example embodiment described above, as illustrated in FIG. 5, the information DB 12 accumulates the operation approval information containing public information and private information.

In contrast, in the present example embodiment, as illustrated in FIG. 13, the information DB 12 accumulates only the private information of the operation approval information (S120).

In addition, in the second example embodiment described above, as illustrated in FIG. 9, the information provision unit 28 searches the information DB 12 of the information accumulation server 2 using the retrieval key (S240). The information provision unit 28 then retrieves the operation approval information that corresponds to the retrieval key above from the information DB 12 (S250).

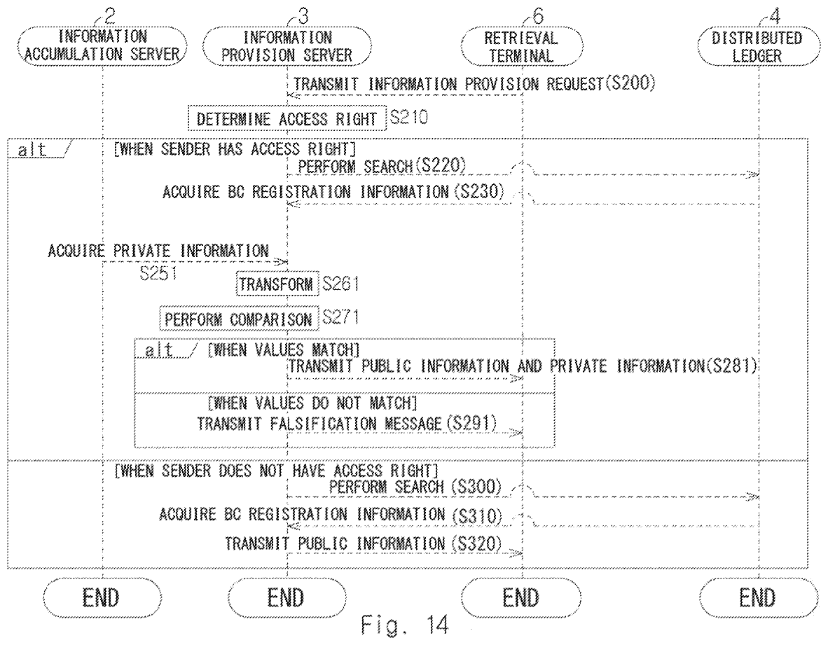

In contrast, in the present example embodiment, as illustrated in FIG. 14, the information provision unit 28 retrieves plural pieces of the private information from the information DB 12 of the information accumulation server 2 (S251). Specifically, the information provision unit 28 retrieves all pieces of the private information accumulated in the information DB 12 of each information accumulation server 2.

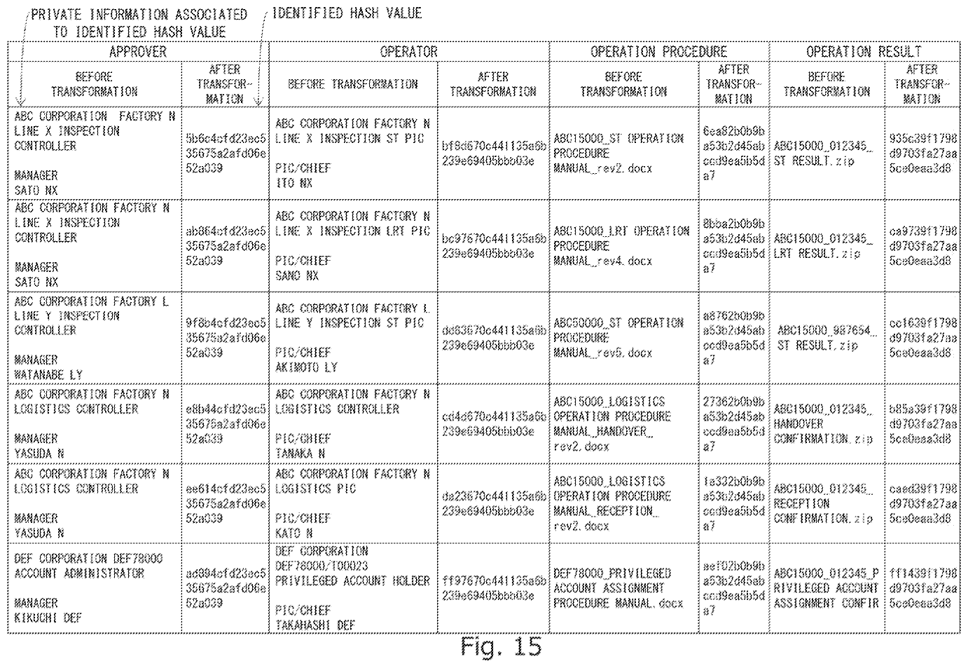

Next, the information provision unit 28 transforms, as illustrated in FIG. 15, the plural pieces of the private information retrieved in step S251 using the predetermined hash function into hash values for verification (S261).

The information provision unit 28 then compares the hash values for registration of the BC registration information retrieved in step S230 with the hash value for verification generated in step S261 (S271).

Subsequently, the information provision unit 28 transmits the public information corresponding to the retrieval key and the private information corresponding to the hash value for verification that matches the hash value for registration to the sender (S281). The process is typically performed as follows.

FIG. 10 illustrates the BC registration information retrieved by the information provision unit 28 from the distributed ledger 4. As illustrated in FIG. 10, two pieces of the BC registration information corresponded to the retrieval key above. Therefore, the information provision unit 28 retrieves the two pieces of the BC registration information illustrated in FIG. 10 (i.e., the BC registration information 4X and the BC registration information 4Y) from the distributed ledger 4.

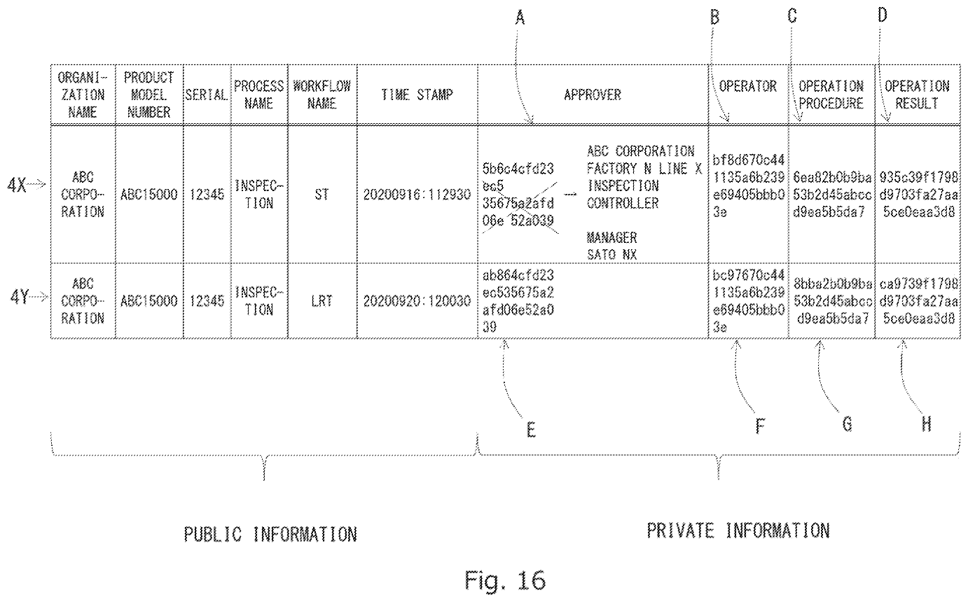

Subsequently, the information provision unit 28 first identifies a hash value of the hash values for verification illustrated in FIG. 15 that matches the hash value for registration A of the BC registration information 4X. The information provision unit 28 then replaces, as illustrated in FIG. 16, the hash value for registration A of the BC registration information 4X with the private information corresponding to the identified hash value for verification. The information provision unit 28 also performs similar processes to the hash value for registration B to the hash value for registration D of the BC registration information 4X. Thus, the BC registration information 4X is converted into the operation approval information. After all of the hash values for registration of the BC registration information 4X are successfully converted into the private information in this way, the information provision unit 28 transmits the public information and the private information to the sender (S281). The BC registration information 4Y is processed in the same manner.

When there are identified more than one of the hash values for verification illustrated in FIG. 15 that matches the hash value for registration A of the BC registration information 4X, the information provision unit 28 determines that the private information stored in the information DB 12 is falsified. When there is identified none of the hash values for verification illustrated in FIG. 15 that matches the hash value for registration A of the BC registration information 4X, the information provision unit 28 determines that the private information stored in the information DB 12 is falsified. The information provision unit 28 then transmits a falsification message indicating that the private information stored in the information DB 12 is falsified to the retrieval terminal 6 (S291).

While the third example embodiment of the present disclosure has been described above, the third example embodiment has the following features.

As illustrated in FIG. 13, the information DB 12 (the first information storing means) accumulates the private information of the operation approval information (the first information). As illustrated in FIG. 14, the information provision unit 28 (the second information transmitting means) searches the distributed ledger 4 using a retrieval key that is at least a portion of public information contained in an information provision request (S220). The information provision unit 28 retrieves the BC registration information (the second information) that corresponds to the retrieval key from the distributed ledger 4 (S230). The information provision unit 28 retrieves plural pieces of the private information accumulated in the information DB 12 from the information DB 12 (S251). The information provision unit 28 transforms the plural pieces of the private information retrieved from the information DB 12 using the predetermined hash function into hash values for verification (the second hash values) (S261). The information provision unit 28 compares the hash value for registration with the hash values for verification (S271). The information provision unit 28 transmits the public information corresponding to the retrieval key and the private information corresponding to one of the hash values for verification that matches the hash value for registration to the sender (S281). The information provision system 1 described above can ensure authenticity of the public information and the private information by means of the distributed ledger and reduce a risk of the private information being leaked. Moreover, since the public information need not be accumulated in the information DB 12 of the information accumulation server 2, the information provision system 1 contributes to reducing resources for the information DB 12.

It should be noted that, in the present example embodiment, the information DB 12 may also accumulate the operation approval information containing public information and private information similarly to the second example embodiment.

The information provision unit 28 determines, when more than one of the hash values for verification matches the hash value for registration or none of the hash values for verification matches the hash value for registration, that the private information accumulated in the information DB 12 is falsified (S291). According to the configuration described above, the private information accumulated in the information DB 12 may be determined to be falsified.

In the examples described above, programs may be stored and supplied to a computer using various types of non-transitory computer-readable media. Non-transitory computer-readable media include various types of tangible storage media. Examples of non-transitory computer-readable media include magnetic recording media (e.g., flexible disks, magnetic tapes, hard disk drives) and magnetooptical recording media (e.g., magneto-optical disks). Further examples of non-transitory computer-readable media include CD-ROM (Read Only Memory) discs, CD-R discs, CD-R/W discs, and semiconductor memories (that includes, for example, mask ROM). Further examples of non-transitory computer-readable media include PROM (Programmable ROM), EPROM (Erasable PROM), flash ROM, and RAM (Random Access Memory). In addition, programs may be supplied to a computer using various types of transitory computer-readable media. Examples of transitory computer-readable media include electric signals, optical signals, and electromagnetic waves. Transitory computer-readable media may enable programs to be supplied to a computer via a wired communication path such as an electric wire or an optical fiber or a wireless communication path.

Some or all of the example embodiments described above may be described as in the following supplementary notes, but are not limited to the following.

(Supplementary note 1)

An information provision system comprising an information accumulation server and an information provision server,
the information accumulation server including:
   first information acquiring means for acquiring first information containing public information and private information;
   first information transmitting means for transmitting the first information acquired by the first information acquiring means to the information provision server; and
   first information storing means for accumulating the first information,
the information provision server including:
   second information acquiring means for acquiring the first information from the information accumulation server;
   transformation means for transforming the private information of the first information into a first hash value by using a predetermined hash function;
   information generating means for generating second information containing the public information of the first information and the first hash value;
   registration means for registering the second information on a distributed ledger by means of a blockchain;
   request receiving means for receiving an information provision request containing at least a part of the public information; and
   second information transmitting means for transmitting, when a sender of the information provision request has an access right to the private information, the public information and the private information to the sender in response to the information provision request, wherein the second information transmitting means is configured to:
   search the distributed ledger by using a retrieval key being at least a part of the public information contained in the information provision request;
   acquire the second information associated to the retrieval key from the distributed ledger;
   search the first information storing means by using the retrieval key;
   acquire the first information associated to the retrieval key from the first information storing means;
   transform the private information acquired from the first information storing means through searching by using the predetermined hash function into a second hash value;
   compare the first hash value with the second hash value; and
   transmit, when the first hash value and the second hash value match, the public information associated to the retrieval key and the private information acquired from the first information storing means through searching, to the sender.
      (Supplementary note 2)

The information provision system according to Supplementary note 1, wherein the second information transmitting means determines, when the first hash value and the second hash value do not match, that the private information accumulated in the first information storing means is falsified.

(Supplementary note 3)

The information provision system according to Supplementary note 1 or 2, wherein the second information transmitting means determines, when the public information of the first information acquired from the first information storing means through searching and the public information of the second information acquired from the distributed ledger do not match, that the public information accumulated in the first information storing means is falsified.

(Supplementary note 4)

The information provision system according to any one of Supplementary notes 1 to 3, wherein the second information transmitting means is configured to:
search, when a sender of the information provision request does not have an access right to the private information, the distributed ledger by using the retrieval key;
acquire the public information of the second information associated to the retrieval key from the distributed ledger; and
transmit the public information acquired from the distributed ledger to the sender.
   (Supplementary note 5)

An information provision system comprising an information accumulation server and an information provision server,
the information accumulation server including:
   first information acquiring means for acquiring first information containing public information and private information;
   first information transmitting means for transmitting the first information acquired by the first information acquiring means to the information provision server; and
   first information storing means for accumulating the private information of the first information,
the information provision server including:
   second information acquiring means for acquiring the first information from the information accumulation server;
   transformation means for transforming the private information of the first information into a first hash value by using a predetermined hash function;
   information generating means for generating second information containing the public information of the first information and the first hash value;
   registration means for registering the second information on a distributed ledger by means of a blockchain;
   request receiving means for receiving an information provision request containing at least a part of the public information; and
   second information transmitting means for transmitting, when a sender of the information provision request has an access right to the private information, the public information and the private information to the sender in response to the information provision request, wherein the second information transmitting means is configured to:
   search the distributed ledger by using a retrieval key as at least a part of the public information contained in the information provision request;
   acquire the second information associated to the retrieval key from the distributed ledger;
   acquire a plurality of pieces of the private information accumulated in the first information acquiring means from the first information storing means;
   transform a plurality of pieces of the private information acquired from the first information storing means by using the predetermined hash function, into second hash values,
   compare the first hash value with a plurality of the second hash values; and
   transmit the public information associated to the retrieval key and the private information associated to one of the second hash values that matches the first hash value, to the sender.
      (Supplementary note 6)

The information provision system according to Supplementary note 5, wherein the second information transmitting means determines, when more than one of the second hash values matches the first hash value or none of the second hash values matches the first hash value, that the private information accumulated in the first information storing means is falsified.

(Supplementary note 7)

The information provision system according to Supplementary note 5 or 6, wherein the second information transmitting means is configured to:
search, when a sender of the information provision request does not have an access right to the private information, the distributed ledger by using the retrieval key;
acquire the public information of the second information associated to the retrieval key from the distributed ledger; and
transmit the public information acquired from the distributed ledger to the sender.
   (Supplementary note 8)

An information provision method using an information provision system including an information accumulation server and an information provision server, the method comprising:
a first information acquisition stage of, by the information accumulation server, acquiring first information containing public information and private information;
a first information transmission stage of, by the information accumulation server, transmitting the first information acquired in the first information acquisition stage, to the information provision server;
a first information storage stage of, by the information accumulation server, accumulating the first information;
a second information acquisition stage of, by the information provision server, acquiring the first information from the information accumulation server;
a transformation stage of, by the information provision server, transforming the private information of the first information into a first hash value by using a predetermined hash function;
an information generation stage of, by the information provision server, generating second information containing the public information of the first information and the first hash value;
a registration stage of, by the information provision server, registering the second information on a distributed ledger by means of a blockchain;
a request reception stage of, by the information provision server, receiving an information provision request containing at least a part of the public information; and
a second information transmission stage of, by the information provision server, transmitting, when a sender of the information provision request has an access right to the private information, the public information and the private information to the sender in response to the information provision request, wherein the second information transmission stage includes:
   searching the distributed ledger by using a retrieval key as at least a part of the public information contained in the information provision request;
   acquiring the second information associated to the retrieval key from the distributed ledger;
   searching the information accumulation server by using the retrieval key;
   acquiring the first information associated to the retrieval key from the information accumulation server;
   transforming the private information acquired from the information accumulation server through searching by using the predetermined hash function into a second hash value;
   comparing the first hash value with the second hash value; and
   transmitting, when the first hash value and the second hash value match, the public information associated to the retrieval key and the private information acquired from the information accumulation server through searching, to the sender.
      (Supplementary note 9)

An information provision method using an information provision system including an information accumulation server and an information provision server, the method comprising:
a first information acquisition stage of, by the information accumulation server, acquiring first information containing public information and private information;
a first information transmission stage of, by the information accumulation server, transmitting the first information acquired in the first information acquisition stage to the information provision server;
a first information storage stage of, by the information accumulation server, accumulating the private information of the first information;
a second information acquisition stage of, by the information provision server, acquiring the first information from the information accumulation server;
a transformation stage of, by the information provision server, transforming the private information of the first information into a first hash value by using a predetermined hash function;
an information generation stage of, by the information provision server, generating second information containing the public information of the first information and the first hash value;
a registration stage of, by the information provision server, registering the second information on a distributed ledger by means of a blockchain;
a request reception stage of, by the information provision server, receiving an information provision request containing at least a part of the public information; and
a second information transmission stage of, by the information provision server, transmitting, when a sender of the information provision request has an access right to the private information, the public information and the private information to the sender in response to the information provision request, wherein the second information transmission stage includes:
   searching the distributed ledger by using a retrieval key as at least a part of the public information contained in the information provision request;
   acquiring the second information associated to the retrieval key from the distributed ledger;
   acquiring a plurality of pieces of the private information accumulated in the information accumulation server from the information accumulation server;
   transforming a plurality of pieces of the private information acquired from the information accumulation server by using the predetermined hash function into second hash values;
   comparing the first hash value with the second hash values; and
   transmitting the public information associated to the retrieval key and the private information associated to one of the second hash values that matches the first hash value, to the sender.
      (Supplementary note 10)

A non-transitory computer-readable medium storing a program that causes a computer to execute the information provision method according to Supplementary note 8.

(Supplementary note 11)

A non-transitory computer-readable medium storing a program that causes a computer to execute the information provision method according to Supplementary note 9.

### REFERENCE SIGNS LIST

1 INFORMATION PROVISION SYSTEM
2 INFORMATION ACCUMULATION SERVER
2X OPERATION APPROVAL INFORMATION
2Y OPERATION APPROVAL INFORMATION
3 INFORMATION PROVISION SERVER
4 DISTRIBUTED LEDGER
4X BC REGISTRATION INFORMATION
4Y BC REGISTRATION INFORMATION
5 OPERATION TERMINAL
6 RETRIEVAL TERMINAL
10 WORKFLOW UNIT
11 INFORMATION TRANSMISSION UNIT
12 INFORMATION DB
20 INFORMATION RECEPTION UNIT
21 HASHING UNIT
22 REGISTRATION INFORMATION GENERATION UNIT
23 BC REGISTRATION UNIT
24 ACCOUNT CREATION UNIT
25 ACCOUNT ASSIGNMENT UNIT
26 ACCOUNT INFORMATION STORAGE UNIT
27 REQUEST RECEPTION UNIT
28 INFORMATION PROVISION UNIT

What is claimed is:

1. An information provision system comprising an information accumulation server and an information provision server,
the information accumulation server including:
at least one first memory storing instructions and
at least one first processor configured to execute the instructions to;
acquire first information containing public information and private information;
transmit the acquired first information to the information provision server; and
accumulate the first information,
the information provision server including:
at least one second memory storing instructions and
at least one second processor configured to execute the instructions to;
acquire the first information from the information accumulation server;
transform the private information of the first information into a first hash value by using a predetermined hash function;
generate second information containing the public information of the first information and the first hash value;
register the second information on a distributed ledger by means of a blockchain;
receive an information provision request containing at least a part of the public information; and
transmit, when a sender of the information provision request has an access right to the private information, the public information and the private information to the sender in response to the information provision request,
wherein the at least one second processor is further configured to:
search the distributed ledger by using a retrieval key being at least a part of the public information contained in the information provision request;
acquire the second information associated to the retrieval key from the distributed ledger;
search the information accumulation server by using the retrieval key;
acquire the first information associated to the retrieval key from the the information accumulation server;
transform the private information acquired from the information accumulation server through searching by using the predetermined hash function into a second hash value;
compare the first hash value with the second hash value; and
transmit, when the first hash value and the second hash value match, the public information associated to the retrieval key and the private information acquired from the information accumulation server through searching, to the sender.

2. The information provision system according to claim 1, wherein the at least one second processor is further configured to determine, when the first hash value and the second hash value do not match, that the private information accumulated in the information accumulation server is falsified.

3. The information provision system according to claim 1, wherein the at least one second processor is further configured to determine, when the public information of the first information acquired from the information accumulation server through searching and the public information of the second information acquired from the distributed ledger do not match, that the public information accumulated in the information accumulation server is falsified.

4. The information provision system according to claim 1, wherein the at least one second processor is further configured to:
search, when a sender of the information provision request does not have an access right to the private information, the distributed ledger by using the retrieval key;
acquire the public information of the second information associated to the retrieval key from the distributed ledger; and
transmit the public information acquired from the distributed ledger to the sender.

5. An information provision system comprising an information accumulation server and an information provision server,
the information accumulation server including:
at least one first memory storing instructions and
at least one first processor configured to execute the instructions to:
acquire first information containing public information and private information;
transmit the acquired first information to the information provision server; and
accumulate the private information of the first information,
the information provision server including:
at least one second memory storing instructions and
at least one second processor configured to execute the instructions to:
acquire the first information from the information accumulation server;
transform the private information of the first information into a first hash value by using a predetermined hash function;
generate second information containing the public information of the first information and the first hash value;
register the second information on a distributed ledger by means of a blockchain;
receive an information provision request containing at least a part of the public information; and
transmit, when a sender of the information provision request has an access right to the private information, the public information and the private information to the sender in response to the information provision request,
wherein the at least one second processor is further configured to:
search the distributed ledger by using a retrieval key as at least a part of the public information contained in the information provision request;
acquire the second information associated to the retrieval key from the distributed ledger;
acquire a plurality of pieces of the private information accumulated in the information accumulation server from the information accumulation server;
transform a plurality of pieces of the private information acquired from means the information accumulation server by using the predetermined hash function, into second hash values,
compare the first hash value with a plurality of the second hash values; and
transmit the public information associated to the retrieval key and the private information associated to one of the second hash values that matches the first hash value, to the sender.

6. The information provision system according to claim 5, wherein the at least one second processor is further configured to determine, when more than one of the second hash values matches the first hash value or none of the second hash values matches the first hash value, that the private information accumulated in the information accumulation server is falsified.

7. The information provision system according to claim 5, wherein the at least one second processor is further configured to:
search, when a sender of the information provision request does not have an access right to the private information, the distributed ledger by using the retrieval key;
acquire the public information of the second information associated to the retrieval key from the distributed ledger; and
transmit the public information acquired from the distributed ledger to the sender.

8. An information provision method using an information provision system including an information accumulation server and an information provision server, the method comprising:
acquiring, by the information accumulation server, first information containing public information and private information;
transmitting, by the information accumulation server, the acquired first information to the information provision server;
accumulating, by the information accumulation server, the first information;
acquiring, by the information provision server, the first information from the information accumulation server;
transforming, the private information of the first information into a first hash value by using a predetermined hash function;
generating, by the information provision server, second information containing the public information of the first information and the first hash value;
registering, by the information provision server, the second information on a distributed ledger by means of a blockchain;
receiving, by the information provision server, an information provision request containing at least a part of the public information; and
transmitting, by the information provision server, when a sender of the information provision request has an access right to the private information, the public information and the private information to the sender in response to the information provision request,
wherein the transmitting by the information provision server includes:
searching the distributed ledger by using a retrieval key as at least a part of the public information contained in the information provision request;
acquiring the second information associated to the retrieval key from the distributed ledger;
searching the information accumulation server by using the retrieval key;
acquiring the first information associated to the retrieval key from the information accumulation server;
transforming the private information acquired from the information accumulation server through searching by using the predetermined hash function into a second hash value;
comparing the first hash value with the second hash value; and
transmitting, when the first hash value and the second hash value match, the public information associated to the retrieval key and the private information acquired from the information accumulation server through searching, to the sender.

9. An information provision method using an information provision system including an information accumulation server and an information provision server, the method comprising:
acquiring, by the information accumulation server, acquiring first information containing public information and private information;
transmitting, by the information accumulation server, the acquired first information to the information provision server;
accumulating, by the information accumulation server, the private information of the first information;
acquiring, by the information provision server, the first information from the information accumulation server;
transforming, by the information provision server, the private information of the first information into a first hash value by using a predetermined hash function;
generating, by the information provision server, second information containing the public information of the first information and the first hash value;
registering, by the information provision server, the second information on a distributed ledger by means of a blockchain;
receiving, by the information provision server, an information provision request containing at least a part of the public information; and
transmitting, by the information provision server, when a sender of the information provision request has an access right to the private information, the public information and the private information to the sender in response to the information provision request,
wherein the transmitting by the information provision server includes:
searching the distributed ledger by using a retrieval key as at least a part of the public information contained in the information provision request;
acquiring the second information associated to the retrieval key from the distributed ledger;
acquiring a plurality of pieces of the private information accumulated in the information accumulation server from the information accumulation server;
transforming a plurality of pieces of the private information acquired from the information accumulation server by using the predetermined hash function into second hash values;
comparing the first hash value with the second hash values; and
transmitting the public information associated to the retrieval key and the private information associated to one of the second hash values that matches the first hash value, to the sender.

10. A non-transitory computer-readable medium storing a program that causes a computer to execute the information provision method according to claim 8.

11. A non-transitory computer-readable medium storing a program that causes a computer to execute the information provision method according to claim 9.
